(19) United States
(12) Patent Application Publication
(10) Pub. No.: US 2013/0304934 A1
(43) Pub. Date: Nov. 14, 2013

(54) METHODS AND SYSTEMS FOR CONTROLLING QUALITY OF A MEDIA SESSION

(71) Applicant: AVVASI INC., WATERLOO (CA)

(72) Inventors: Anthony P. Joch, Waterloo (CA); Roman C. Kordasiewicz, Elmira (CA); Michael Gallant, Kitchener (CA); Kevin Goertz, Waterloo (CA)

(21) Appl. No.: 13/852,796

(22) Filed: Mar. 28, 2013

Related U.S. Application Data
(63) Continuation-in-part of application No. 13/631,366, filed on Sep. 28, 2012.
(60) Provisional application No. 61/719,989, filed on Oct. 30, 2012.
(60) Provisional application No. 61/541,046, filed on Sep. 29, 2011.

(51) Int. Cl. H04L 29/06

(52) U.S. Cl. CPC H04L 65/607
USPC 709/231

(57) ABSTRACT

Methods and systems for controlling quality of a media stream in a media session. The described methods and system control the quality of the media stream by controlling transcoding of the media session. The transcoding is controlled at the commencement of the media session and dynamically during the life of the media session. The transcoding is controlled by selecting a target quality of experience (QoE) for the media session, computing a predicted QoE for each of a plurality of control points, where each control point has a plurality of transcoding parameters associated therewith, selecting an control point of the plurality of control points, wherein the predicted QoE for the selected control point substantially corresponds with the target QoE and signaling the transcoder to use the selected control point for the media session.

### FIELD

The described embodiments relate to controlling quality of experience of a media session. In particular, the described embodiments relate to controlling quality of a media session to correspond to a target quality of experience.

### BACKGROUND

The popularity of streaming media content over the internet and other networks continues to increase. Maintaining such streaming is becoming a problem for the organizations providing and maintaining such networks. Streaming media has become an important element of the “Internet” experience through the significant availability of content from sites like YouTube™, Netflix™ and many others

Multimedia content on the Internet tends to be diverse and unmanaged. Internet multimedia content is diverse across many variables, such as, formats, quality levels, resolution, bit rates etc. and is consumed on a wide range of devices. The diversity can be better managed by organizing and delivering multimedia content according to a common quality metric that normalizes across such variables.

### SUMMARY

In general, the described embodiments may use one or more models to predict one or more perceptual quality metrics for, and which reflect a viewer's satisfaction or quality of experience (QoE) with, a media session. The models may operate over “prediction horizons”. The models may be based on content complexity (motion, texture), quantization level, frame rate, resolution, and target device. The models may also be based on network conditions such as expected throughput, expected encoding bit rate, and the state of the encoder output and client playback buffers.

A quantization level, frame rate, resolution for a given content complexity and target device can largely determine the quality level which generally correlates to a QoE. A particular set of values for each of these parameters may define an operating point or control point for a media session. A control point may be selected from a set of possible control points via filtering such that only those that can achieve the target quality level are considered. The filtered control points are each considered and a best control point is selected based on criteria that include: minimizing the bit rate, minimizing transcoding resource requirements, satisfying additional policy constraints (e.g., subscriber X may be prohibited from receiving an HD resolution video), etc.

Calculation of the predicted quality level may be influenced by the viewing client device, content characteristics, subscriber preferences, etc. For example, a larger screen at the client device typically requires a higher resolution for equivalent quality level as compared to a smaller screen. Likewise, high action (e.g., sports) content typically requires a high frame rate to achieve adequate quality level. Subscribers may have preferences for finer quantization levels, e.g. less blocking, at the cost of lower frame rate and/or resolution (or vice-versa).

Insufficient network throughput, a shallow client buffer, or combinations of the two may lead to unacceptable startup delays or re-buffering which generally degrades the quality level and therefore the QoE. By changing the quantization levels, frame rates, or resolutions, bit rates may be further reduced to ensure uninterrupted playback. Additional constraints on the control points may therefore be applied to ensure uninterrupted playback and further filter the set.

Once a control point is selected for a media session, it may be periodically re-evaluated. To minimize frequent changes in control point, the selection of a new or updated control point may be made with an eye on a “prediction horizon” (e.g., a predetermined time window for which the control point is expected to be suitable).

Initial immutable or fixed parameters for a media session may be selected by anticipating the range of bit rates/quality-levels that are likely to be encountered in a media session lifetime and making static (session start time) decisions based on this knowledge. Such parameters may be selected to provide most flexibility (optimize quality over likely range of conditions) over the life of a media session.

In some cases, consistent perceptual quality can be provided by re-using quantization information from the input bitstream. This generally produces variable bit rate (VBR) streams, since more complex scenes require a higher bit rate than less complex scenes in order to achieve the same perceptual quality. More complex scenes can also be encoded with higher levels of quantization than less complex scenes while achieving similar levels of perceptual quality. Reuse of quantization information from the input bitstream produces a more consistent perceptual quality because the input bitstreams generally use VBR encoding and have been produced using multi-pass encoding, which leads to optimal bit allocation from scene-to-scene.

In some other cases, the quantization level pattern of the input bitstream from scene to scene can be leveraged during transcoding, in order to benefit from the optimal bit rate allocation determined by the original multi-pass encoding. For example, if an input bitstream has a quantization level pattern of 30-20-40, the transcoded quantization level pattern may follow a similar pattern of 15-10-20.

In a first broad aspect, there is provided a method of controlling transcoding of a media session by a transcoder on a network, the method comprising: selecting a target quality of experience (QoE) for the media session; for each of a plurality of control points, computing a predicted QoE associated with the control point, wherein each control point has a plurality of transcoding parameters associated therewith; selecting an initial control point of the plurality of control points, wherein the predicted QoE for the initial control point substantially corresponds with the target QoE; and signaling the transcoder to use the initial control point for the media session.

The initial control point may be selected based on an optimization function.

In some cases, the method further comprises determining that a real-time QoE for the media session does not substantially correspond with the target QoE; for each of the plurality of control points, re-computing the predicted QoE, wherein the predicted QoE is based on a real-time QoE for the media session; selecting an updated control point from the plurality of control points, wherein the predicted QoE for the updated control point substantially corresponds with the target QoE; and signaling the transcoder to use the updated control point for the media session.

In some cases, the method further comprises determining a client buffer condition, wherein the updated control point is selected based on the client buffer condition.

The updated control point may be selected based on an optimization function. A policy rule may be an input to the optimization function. At least one device capability of a device receiving the media session may be an input to the optimization function. A bit rate of the media session may be an input to the optimization function. Transcoding resource requirements may be an input to the optimization function. The plurality of transcoding parameters may comprise at least one parameter selected from the group consisting of: quantization level, resolution, and frame rate.

The predicted QoE may be computed for a predetermined forward window, and wherein the selected control point is selected to substantially correspond with the target QoE over the length of the predetermined forward window.

The target QoE may comprise a QoE range. QoE may be computed based on at least one of a presentation quality score and a delivery quality score.

In another broad aspect, there is provided an apparatus for controlling transcoding of a media session by a transcoder on a network, the apparatus comprising: a memory; a network interface, a processor, the processor configured to carry out the methods described herein, comprising: select a target quality of experience (QoE) for the media session; for each of a plurality of control points, compute a predicted QoE associated with the control point, wherein each control point has a plurality of transcoding parameters associated therewith; select an initial control point of the plurality of control points, wherein the predicted QoE for the initial control point substantially corresponds with the target QoE; and signal the transcoder to use the initial control point for the media session.

In some cases, the processor is further configured to: determine that a real-time QoE for the media session does not substantially correspond with the target QoE; for each of the plurality of control points, re-computing the predicted QoE, wherein the predicted QoE is based on a real-time QoE for the media session; select an updated control point from the plurality of control points, wherein the predicted QoE for the updated control point substantially corresponds with the target QoE; and signal the transcoder to use the updated control point for the media session.

In some cases, the processor is further configured to determine a client buffer condition, wherein the updated control point is selected based on the client buffer condition.

In some cases, the processor is further configured to select the updated control point based on an optimization function.

In some cases, the processor is configured to compute the predicted QoE for a predetermined forward window, and the processor is configured to select the updated control point to substantially correspond with the target QoE over the length of the predetermined forward window,

In another broad aspect, there is provided a non-transitory computer-readable medium storing computer-executable instructions, the instructions for causing a processor to perform a method of controlling transcoding of a media session by a transcoder on a network as described herein, the method comprising, for example: selecting a target quality of experience (QoE) for the media session; for each of a plurality of control points, computing a predicted QoE associated with the control point wherein each control point has a plurality of transcoding parameters associated therewith; selecting an initial control point of the plurality of control points, wherein the predicted QoE for the initial control point substantially corresponds with the target QoE; and signaling the transcoder to use the Initial control point for the media session.

### BRIEF DESCRIPTION OF THE DRAWINGS

Preferred embodiments will now be described in detail with reference to the drawings, in which:

FIG. 1 is a block diagram of a network with a media session control system in accordance with an example embodiment;

FIG. 2A is a block diagram of a media session control system in accordance with an example embodiment;

FIG. 2B is an example process flow that may be followed by an evaluator of a QoE controller;

FIG. 3 is an example process flow that may be followed by a QoE controller; and

FIG. 4 is another example process flow that may be followed by a QoE controller.

The drawings are provided for the purposes of illustrating various aspects and features of the example embodiments described herein. Where considered appropriate, reference numerals may be repeated among the figures to indicate corresponding or analogous elements.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, mobile telephone, smartphone or any other computing device capable of being configured to carry out the methods described herein.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a non-transitory computer readable storage medium (e.g. read-only memory, magnetic disk, optical disc). The storage medium so configured causes a computer to operate in a specific and predefined manner to perform the functions described herein,

While particular combinations of various functions and features are expressly described herein, other combinations of these features and functions are possible that are not limited by the particular examples disclosed herein, and these are expressly incorporated within the scope of the present invention.

As the term module is used in the description of the various embodiments, a module includes a functional block that is implemented in hardware or software, or both, that performs one or more functions such as the processing of an input signal to produce an output signal. As used herein, a module may contain submodules that themselves are modules.

The described methods and systems generally allow the quality of a media session to be adjusted or controlled in order to correspond to a target quality. In some embodiments, the quality of the media session can be controlled by encoding the media session. Encoding is the operation of converting a media signal, such as, an audio and/or a video signal from a source format, typically an uncompressed format, to a compressed format. A format is defined by characteristics such as bit rate, sampling rate (frame rate and spatial resolution), coding syntax, etc.

In some other embodiments, the quality of the media session can be controlled by transcoding the media session. Transcoding is the operation of converting a media signal, such as, an audio signal and/or a video signal, from one format into another. Transcoding may be applied, for example, in order to change the encoding format (e.g. from H.264 to VP8), or for bit rate reduction to adapt media content to an allocated bandwidth.

In some further embodiments, the quality of a media session that is delivered using an adaptive streaming protocol can be controlled using methods applicable specifically to such protocols. Examples of adaptive streaming control include request-response modification, manifest editing, conventional shaping or policing, and may include transcoding. In adaptive streaming control approaches, request-response modification may cause client segment requests for high definition content to be replaced with similar requests for standard definition content. Manifest editing may include modifying the media stream manifest files that are sent in response to a client request to modify or reduce the available operating points in order to control the operating points that are available to the client. Accordingly, the client may make further requests based on the altered manifest. Conventional shaping or policing may be applied to adaptive streaming to limit the media session bandwidth, thereby forcing the client to remain at or below a certain operating point.

Media content is typically encoded or transcoded by selecting a target bit rate. Conventionally, quality is assessed based on factors such as format, encoding options, resolutions and bit rates. The large variety of options, coupled with the wide range of devices on which content may be viewed, has conventionally resulted in widely varying quality across sessions and across viewers. Adaptation based purely on bit rate reduction, does little to improve this situation. It is generally beneficial if the adaptation is based on one or more targets for one or more quality metrics that can normalize across these options.

The described methods and systems, however, may control quality of the media session by selecting a target quality level in a more comprehensive quality metric, for example based on quality of experience. In some cases, the quality metric may be in the form of a numerical score. In some other cases, the quality metric may be in some other form, such as, for example, a letter score, a descriptive (e.g. ‘high’, ‘medium’, ‘low’) etc. The quality metric may be expressed as a range of scores or an absolute score.

A Quality of Experience (QoE) measurement on a Mean Opinion Score (MOS) scale is one example of a perceptual quality metric, which reflects a viewers opinion of the quality of the media session. For ease of understanding, the terms perceptual quality metric and QoE metric may be used interchangeably herein. However, a person skilled in the art will understand that other quality metrics may also be used.

A QoE score or measurement can be considered a subjective way of describing how well a user is satisfied with a media presentation. Generally, a QoE measurement may reflect a user's actual or anticipated of the viewing quality of the media session. Such a calculation may be based on events that impact viewing experience, such as network induced re-buffering events wherein the playback stalls. In some cases, a model of human dissatisfaction may be used to provide QoE measurement. For example, a user model may map a set of video buffer state events to a level of subjective satisfaction for a media session. In some other cases, QoE may reflect an objective score where an objective session model may map a set of hypothetical video buffer state events to an objective score for a media session.

A QoE score may in some cases consist of two separate scores, for example a Presentation Quality Score (PQS) and a Delivery Quality Score (DQS). PQS generally measures the quality level of a media session, taking into account the impact of media encoding parameters and optionally device-specific parameters on the user experience, while ignoring the impact of delivery. For PQS calculation, relevant audio, video and device key performance indicators (KPIs) may be considered from each media session. These parameters may be incorporated into a no-reference bitstream model of satisfaction with the quality level of the media session.

KPIs that can be used to compute the PQS may include codec type, resolution, bits per pixel, frame rate, device type, display size, and dots per inch. Additional KPIs may include coding parameters parsed from the bitstream, such as macroblock mode, macroblock quantization parameter, coded macroblock size in bits, intra prediction mode, motion compensation mode, motion vector magnitude, transform coefficient size, transform coefficient distribution and coded frame size etc. The PQS may also be based, at least in part, on content complexity and content type (e.g., movies, news, sports, music videos etc.). The PQS can be computed for the entirety of a media session, or computed periodically throughout a media session.

DQS measures the success of the network in streaming delivery, reflecting the impact of network delivery on QoE while ignoring the source quality. DQS calculation may be based on a set of factors, such as, the number, frequency and duration of re-buffering events, the delay before playback begins at the start of the session of following a seek operation, buffer fullness measures (such as average, minimum and maximum values over various intervals), and durations of video downloaded/streamed and played/watched. In cases where adaptive bit rate streaming is used, additional factors may include a number of stream switch events, a location in the media stream, duration of the stream switch event, and a change in operating point for the stream switch event.

Simply reporting on the overall number of stalls or stall frequency per playback minute may be insufficient to provide a reliable representation of QoE. To arrive at an accurate DOS score, the model may be tested with, and correlated to, numerous artifact scenarios, using a representative sample of viewers.

Further details relating to the computation of such metrics may be found, for example, in U.S. patent application Ser. Nos. 13/283,898,13/480,964 and 13/053,650.

The described methods and systems may enable service provides to provide their subscribers with assurance that content accessed by the subscribers conform to one or more agreed upon quality levels. This may enable creation of pricing models based on the quality of the subscriber experiences.

The described methods and systems may also enable service providers to provide multimedia content providers and aggregators with assurance that the content is delivered at one or more agreed upon quality levels. This may also enable creation of pricing models based on the assured level of content quality.

The described methods and system may further enable service providers to deliver the same or similar multimedia quality across one or more disparate sessions in a given network location.

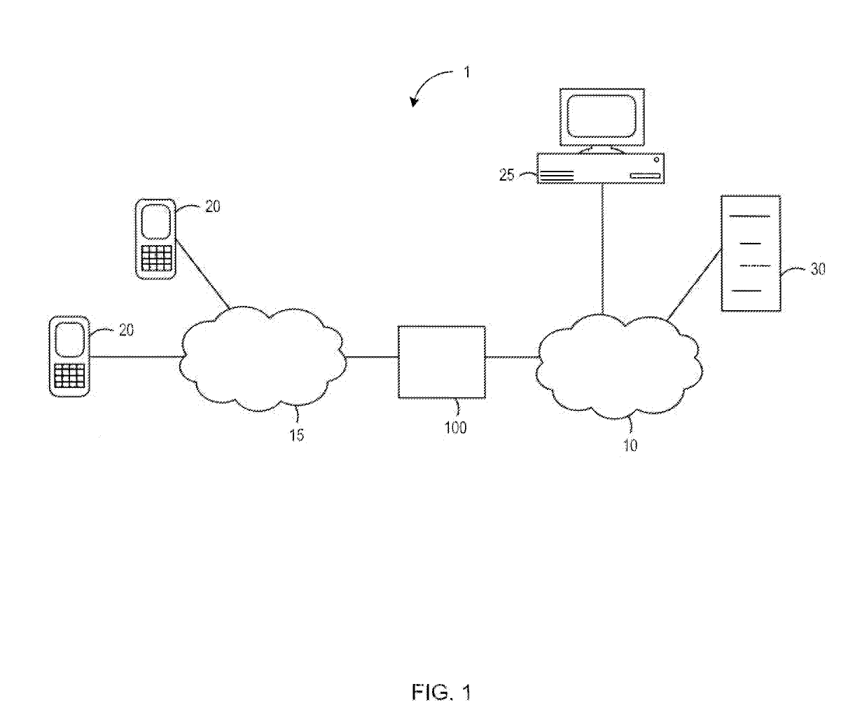

Referring now to FIG. 1, there is illustrated a simplified block diagram of a network system with an example media session control system.

System 1 generally includes a data network 10, such as the Internet, which connects a media server 30, a personal computer 25 and a media session control system 100.

Media session control system 100 is further connected to one or more access networks 15 for client devices 20, which may be mobile computing devices such as smartphones, for example. Accordingly, access networks 15 may include radio access networks (RANs) and backhaul networks, in the case of a wireless data network. Although the exemplary embodiments are shown primarily in the context of mobile data networks, it will be appreciated that the described systems and methods are also applicable to other network configurations. For example, the described systems and methods could be applied to data networks using satellite, digital subscriber line (DSL) or data over cable service interface specification (DOCSIS) technology in lieu of, or in addition to a mobile data network.

Media session control system 100 is generally configured to forward data packets associated with the data sessions of each client device 20 to and from network 10, preferably with minimal latency. In some cases, as described herein further, media session control system 100 may modify the data sessions, particularly in the case of media sessions (e.g., streaming video or audio).

Client devices 20 generally communicate with one or more servers 30 accessible via network 10. It will be appreciated that servers 30 may not be directly connected to network 10, but may be connected via intermediate networks or service providers. In some cases, servers 30 may be edge nodes of a content delivery network (CDN).

It will be appreciated that network system 1 shows only a subset of a larger network, and that data networks will generally have a plurality of networks, such as network 10 and access networks 15.

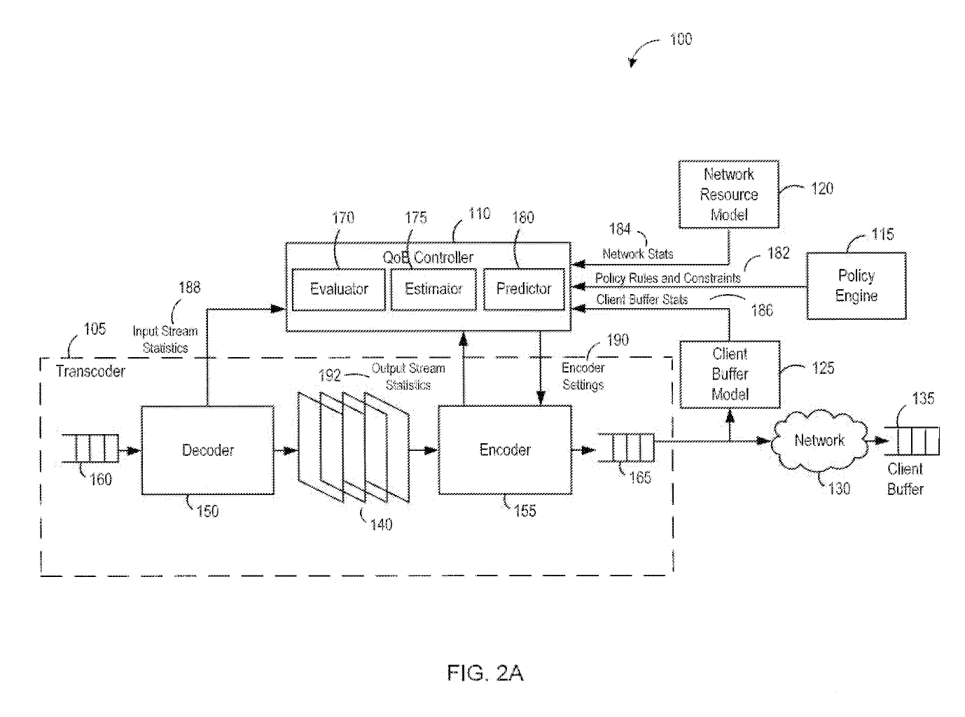

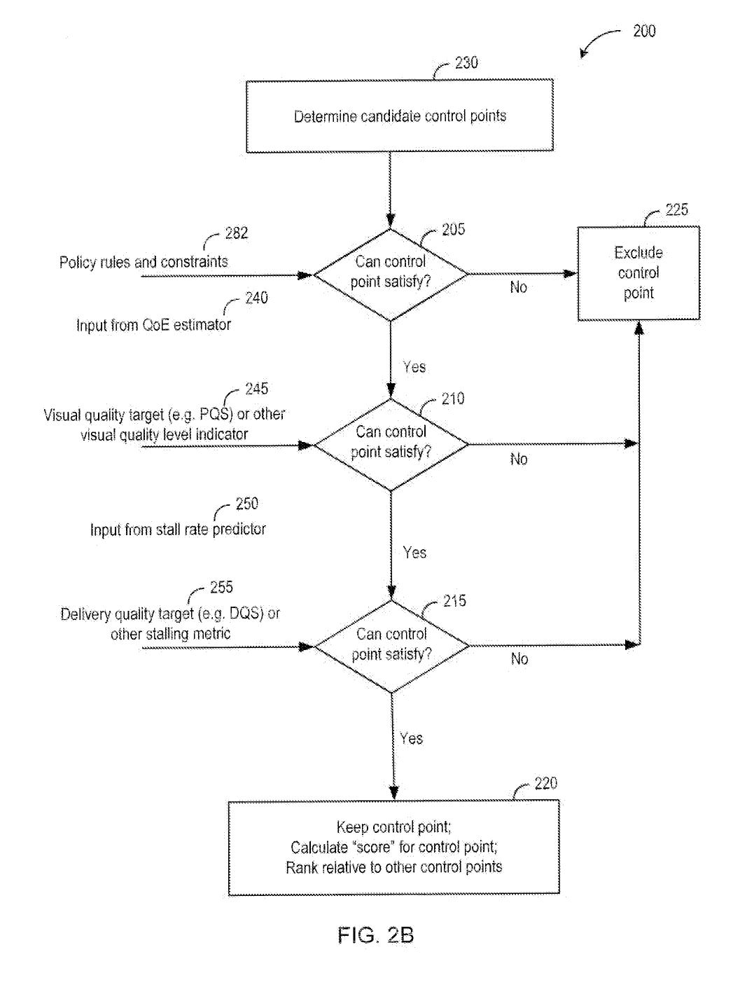

Referring now to FIG. 2A, there is illustrated a simplified block diagram of an example media session control system 100, such as system 100 of FIG. 1. Control system 100 generally has a transcoder 105, a QoE controller 110, a policy engine 115, a network resource model module 120, a client buffer model module 125. Control system 100 is generally in communication with a client device which is receiving data into its client buffer 135, via a network 130.

### Policy Engine

Policy Engine 115 may maintain a set of policies, and other configuration settings in order to perform active control and management of media sessions. In various cases, the policy engine 115 is configurable by the network operator. The configuration of the policy engine 115 may be dynamically changed by the network operator. For example, in some embodiments, policy engine 115 may be implemented as part of a Policy Charging and Rules Function (PCRF) server.

Policy engine 115 provides policy rules and constraints 182 to the QoE controller 110 to be used for a media session under management by system 100. Policy rules and constraints 182 may include one or more of a quality metric and an associated target quality level, a policy action, scope or constraints associated with the policy action, preferences for the media session characteristics, etc. Policy rules and constraints 182 can be based on the subscriber or client device, or may be based on other factors.

The target quality level may be an absolute quality level, such as, a numerical value on a MOS scale. The target quality level may alternatively be a QoE range, i.e., a range of values with a minimum level and a maximum level.

Policy engine 115 may specify a wide variety of quality metrics and associated target quality levels. In some cases, the quality metric may be based on an acceptable encoding and display quality, or a presentation QoE score (PQS). In some other cases, the quality metric may be based on an acceptable network transmission and stalling impact on quality, or a delivery QoE score (DQS). In some further cases, the quality metric may be based on the combination of the presentation and the delivery QoE scores, or a combined QoE score (COS).

Policy engine 115 may determine policy actions for media session, which may include a plurality of actions. For example, a policy action may include a transcoding action, an adaptive streaming action which may also include a transcoding action, or some combination thereof.

Policy engine 115 may specify the scope or constraints associated with policy actions. For example, policy engine 115 may specify constraints associated with a transcoding action. Such constraints may include specifying the scope of one or more individual or aggregate media session characteristics. Examples of media session characteristics may include bit rate, resolution, frame rate, etc. Policy engine 115 may specify one or more of a target value, a minimum value and a maximum value for the media session characteristics.

Policy engine 115 may also specify the preference for the media session characteristic as an absolute value, a range of values and/or a value with qualifiers. For example, policy engine 115 may specify a preference with qualifiers for the media session characteristic by providing that the minimum frame rate value of 10 is a ‘strong’ preference. In other examples, policy engine 115 may specify that the minimum frame rate value is a ‘medium’ or a ‘weak’ preference.

### Network Resource Model Module

Network Resource Model (NRM) module 120 may implement a hierarchical subscriber and network model and a load detection system that receives location and bandwidth information from the rest of the system (e.g., networks 10 and 15 of system 1) or from external network nodes, such as radio access network (RAN) probes, to generate and update a real-time model of the state of a mobile data network, in particular congested domains, e.g. sectors.

NRM module 120 may update and maintain a NRM based on data from at least one network domain, where the data may be collected by a network event collector (not shown) using one or more node feeds or reference points. The NRM module may implement a location-level congestion detection algorithm using measurement data, including location, RTT, throughput, packet loss rates, windows sizes, and the like, NRM module 120 may receive updates to map subscribers and associated traffic and media sessions to locations.

NRM module 120 provides network statistics 184 to the QoE controller 110. Network statistics 184 may include one or more of the following statistics, such as, for example, current bit rate/throughput for session, current sessions for location, predicted bit rate/throughput for session, and predicted sessions for location, etc.

### Client Buffer Model Module

Client buffer model module 125 may use network feedback and video packet timing information specific to a particular ongoing media session to estimate the amount of data in a client device's playback buffer at any point in time in the media session.

Client buffer model module 125 generally uses the estimates regarding amount of data in a client device's playback buffer, such as client buffer 135, to model location, duration and frequency of stall events. In some cases, the client buffer model module 125 may directly provide raw data to the QoE controller 110 so that it may select a setting that minimizes the likelihood of stalling, with the goal of achieving better streaming media performance and improved QoE metric, where the QoE metric can include presentation quality, delivery quality or other metrics.

Client buffer model module 125 generally provides client buffer statistics 186 to the QoE controller 110. Client buffer statistics 186 may include one or more of statistics such as current buffer fullness, buffer fill rate, a playback indicator/time stamp at the client buffer, and an input indicator/timestamp at the client buffer, etc.

### Transcoder

Transcoder 105 generally includes a decoder 150 and an encoder 155. Decoder 150 has an associated decoder input buffer 160 and encoder 155 has an associated encoder output buffer 165, each of which may contain bitstream data.

Decoder 150 may process the input video stream at an application and/or a container layer level and, as such, may include a demuxer. Decoder 140 provides input stream statistics 188 to the QoE controller 110. Input stream statistics 188 may include one or more statistics or information about the input stream. The input stream may be a video stream, an audio stream, or a combination of the video and the audio streams.

Input stream statistics 188 provided to the QoE controller 110 may include one or more of streaming protocol, container type, device type, codec, quantization parameter values, frame rate, resolution, scene complexity estimate, picture complexity estimate, Group of Pictures (GOP) structure, picture type, bits per GOP, bits per picture, etc.

Encoder 155 may be a conventional video or audio encoder and, in some cases, may include a muxer or remuxer. Encoder 155 typically receives decoded pictures 140 and encodes them according to one or more encoding parameters. Encoder 155 typically handles picture type selection, bit allocation within the picture to achieve the overall quantization level selected by control point evaluation, etc. Encoder 155 may include a look-ahead buffer to enable such decision making. Encoder may also include a scaler/resizer for resolution and frame rate reduction. Encoder 155 may make decisions based on encoder settings 190 received from the QoE controller 110.

Encoder 155 provides output stream statistics 192 to the QoE controller 110. Output stream statistics 192 may include one or more of the following statistics or information about the transcoded/output stream, such as, for example, container type, streaming protocol, codec, quantization parameter values, scene complexity estimate, picture complexity estimate, GOP structure, picture type, frame rate, resolution, bits/GOP, bits/picture, etc.

### QoE Controller

QoE Controller 110 is generally configured to select one control point from a set of control points during a control point evaluation process. A control point is set of attributes that define a particular operating point for a media session, which may be used to guide an encoder, such as encoder 155, and/or a transcoder, such as transcoder 105. The set of attributes that make up a control point may be transcoding parameters, such as, for example, resolution, frame rate, quantization level etc.

In some cases, the QoE controller 110 generates various control points. In some other cases, QoE controller 110 receives various control points via network 130. The QoE controller 110 may receive the control points, or constraints for control points, from the policy engine 115 or some external processor.

In some cases, the media streams that represent a particular control point may already exist on a server (e.g. for adaptive streams) and these control points may be considered as part of the control point evaluation process. Selecting one of the control points for which a corresponding media stream already exists may eliminate the need for transcoding to achieve the control point. In such cases, other mechanisms such as shaping, policing, and request modification may be applied to deliver the media session at the selected control point.

Control point evaluation may occur at media session initiation as well as dynamically throughout the course of the session. In some cases, some of the parameters associated with a control point may be immutable once selected (e.g., resolution in some formats).

QoE controller 110 provides various encoder settings 190 to the transcoder 105 (or encoder or adaptive stream controller). Encoder settings 190 may include resolution, frame rate, quantization level (i.e., what amount of quantization to apply to the stream, scene, or picture), bits/frame, etc.

QoE controller 110 may include various modules to facilitate the control point evaluation process. Such modules generally include an evaluator 170, an estimator 175 and a predictor 180.

### Stall Predictor

Predictor 180—which may also be referred to as stall predictor 180—is generally configured to predict a “stalling” bit rate for a media session over a certain “prediction horizon”. Predictor 180 may predict the “stall” bit rate by using some or all of the expected bit rate for a given control point, the amount of transcoded data currently buffered within the system (waiting to be transmitted), the amount of data currently buffered on the client (from the Client Buffer Model module 125), and the current and predicted network throughput.

The “stall” bit rate is the output media bit rate at which a client buffer model expects that playback on the client will stall given its current state and a predicted network throughput, over a given “prediction horizon”. The “stall” bit rate may be used by the evaluator 170 as described herein.

### Visual Quality Estimator

Estimator 175—which may also be referred to as visual quality estimator 175—is generally configured to estimate encoding results for a given control point and the associated visual or coding and device impact on QoE for each control point. This may be achieved using a function or model which estimates a QoE metric, e.g. PQS, as well as the associated bit rate.

Estimator 175 may also be generally configured to estimate transmission results for a given control point and the associated stalling or delivery impact on QoE for each control point. This may be achieved using a function or model which estimates the impact of delivery impairments on a QoE metric (e.g. DQS). Estimator 175 may also model, for each control point, a combined or overall score, which considers all of visual, device and delivery impact on QoE.

### Evaluator

Evaluator 170 is generally configured to evaluate a set of control points based on their ability to satisfy policy rules and constraints, such as policy rules and constraints 182 and achieve a target QoE for the media session. Control points may be re-evaluated periodically throughout the session.

A change in control point is typically implemented by a change in the quantization level, which is a key factor in determining quality level (and associated bit rate) of the encoded or transcoded video. In some cases, the controller may also change the frame rate, which affects the temporal smoothness of the video as well as the bit rate. In some further cases, the controller may also change the video resolution if permitted by the format, which affects the spatial detail as well as the bit rate.

In some cases, the evaluator 170 detects that network throughput is degraded, resulting in degraded QoE. Current or imminently poor DQS may be detected by identifying client buffer fullness (for example by using a buffer fullness model), TCP retries, RTT, window size, etc. Upon detecting a current or imminently degraded network throughout, the evaluator 170 may select control points with a reduced bit rate to ensure uninterrupted playback, thereby maximizing overall QoE score. A lower bit rate, and accordingly a higher DQS, also may be achievable by allowing a reduced PQS.

In various cases, the control point evaluation is carried out in two stages. A first stage may include filtering of control points based on absolute criteria, such as removing control points that do not meet all constraints (e.g., policy rules and constraints 182). A second stage may include scoring and ranking of the set of the filtered control points that meet all constraints, that is, selecting the best control point based on certain optimization criteria.

In the first stage, control points are removed if they do not meet applicable policies, PQS targets, DQS targets, or a combination thereof. For example, if the operator has specified a minimum frame rate (e.g. 12 frames per second), then points with a frame rate less than the minimum fail this selection.

To filter control points based on PQS, evaluator 170 may evaluate the estimated PQS for the control points based on parameters such as, for example, resolution, frame rate, quantization level, client device characteristics (estimated viewing distance and screen size), estimated scene complexity (based on input bitstream characteristics), etc.

To filter control points based on DQS, evaluator 170 may estimate a bit rate that a particular control point will produce based on similar parameters such as, for example, resolution, frame rate, quantization level, estimated scene complexity (based on input bitstream characteristics), etc. If the estimated bit rate is higher than what is expected or predicted to be available on the network (in a particular sector or network node), the control point may be excluded.

In some cases, evaluator 170 may estimate bit rate based on previously generated statistics from previous encodings at one or more of the different control points, if such statistics are available.

In the second stage, an optimization score is computed for each of the qualified control points that meet the constraints of the first stage. In some cases, the score may be computed based on a weighted sum of a number of penalties. For example, penalties may be assigned based on an operator preference expressed in a policy. For example, an operator could specify a strong, moderate, or weak preference to avoid frame rates below 10 fps. Such a preference can be specified in a policy and used in the computation of the penalties for each control point. In some other cases, other ways of computing a score for the control points may be used,

In cases where the score is computed based on the penalties, various factors determining optimality of each control point in a system may be considered. Such factors may include expected output bit rate, the amount of computational resources required in the system, and operator preferences expressed as a policy. The computational resources required in the system may be computed using the number of output macroblocks per second of the output configuration. In general, the use of fewer computational resources (e.g., number of cycles required) is preferred, as this may use less power and/or allow simultaneous transcoding of more channels or streams.

In various cases, the penalty for each control point may be computed as a weighted sum of the output bit rate (e.g., estimated kilobits per second), amount of computational resources (e.g., number of cycles required, output macroblocks per second, etc.), or operator preferences expressed as policy (e.g., frame rate penalty, resolution penalty, quantization penalty, etc.). This example penalty calculation also can be expressed by way of the following optimization function:

Penalty=Wb*Estimated kilobits per second+Wc*Output macroblocks per second+Wf*Frame Rate Penalty+Wr*Resolution Penalty+Wq*Quantization Penalty

Each part of the penalty may have a weight W determining how much the part contributes to the overall penalty. In some cases, the frame rate, resolution and quantization may only contribute if they are outside the range of preference as specified in a policy.

For example, if the operator specifies a preference to avoid transcoding to frame rates less than 10 fps, the frame rate penalty may be computed as outlined in the pseudocode below:

If output frame rate >= 10:

Frame Rate Penalty = 0

Else:

If Frame Rate Preference is Strong:

Frame Rate Penalty = Strong Penalty

Else If Frame Rate Preference is Moderate:

Frame Rate Penalty = Moderate Penalty

Else If Frame Rate Preference is Weak:

Frame Rate Penalty = Weak Penalty

Similarly, if the operator specifies a preference to avoid transcoding to a vertical resolution lower than 240 pixels, the frame rate penalty may be computed as:

If output height >= 240 pixels:

Resolution Penalty = 0

Else:

If Resolution Preference is Strong:

Resolution Penalty = Strong Penalty

Else If Resolution Preference is Moderate:

Resolution Penalty = Moderate Penalty

Else if Resolution Preference is Weak:

Resolution Penalty = Weak Penalty

In some cases, the resolution preference may be expressed in terms of the image width. In some further cases, the resolution preferences may be expressed in terms of the overall number of macroblocks.

The strength of the preference specified in the policy, such as Strong/Moderate/Weak, may determine how much each particular element contributes to the scoring of the control points that are not in the desired range. For example, values of the Strong, Moderate, and Weak Penalty values might be 300, 200, and 100, respectively. The operator may specify penalties in other ways, having any suitable number of levels where any suitable range of values may be associated with those levels.

In cases, where the scoring is based on penalties, lower scores will generally be more desirable. However, scoring may instead be based on “bonuses”, in which case higher scores would be more desirable. It will be appreciated that various other scoring schemes also can be used.

Once the various scores corresponding to various candidate control points are determined, the evaluator 170 selects the control point with the best score (e.g., lowest overall penalty).

Reference is next made to FIG. 2B, illustrating a process flow diagram according to an example embodiment. Process flow 200 may be carried out by evaluator 170 of the QoE controller 110. The steps of the process flow 200 are illustrated by way of an example input bit rate with resolution 854×480 and frame rate 24 fps, although it will be appreciated that the process flow may be applied to an input bit rate of any other resolution and frame rate.

Upon receiving the resolution and frame rate information regarding the input bit rate, the evaluator 170 of the QoE controller 110 determines various candidate output resolutions and frame rate. The various combinations of the candidate resolutions and frame rates may be referred to as candidate control points 230.

For example, for the input bit rate with resolution 854×480, the various candidate output resolutions may include resolutions of 854×480, 640×360, 572×320, 428×240, 288×160, 216×120, computed by multiplying the width and the height of the input bit rate by multipliers 1, 0.75, 0.667, 0.5, 0.333, 0.25.

Similarly, for the input bit rate with a frame rate of 24 fps, the various candidate output frame rates may include frame rates of 24, 12, 8, 6, 4.8, 4, derived by dividing the input frame rate by divisors 1, 2, 3, 4, 5, 6.

Various combinations of candidate resolutions and candidate frame rates can be used to generate candidate control points. In this example, there are 36 such control points. Other parameters may also be used in generating candidate control points as described herein, although these are omitted in this example to aid understanding.

At 205, the evaluator 170 determines which of the candidate control points 230 satisfy the policy rules and constraints 282 received from a policy engine, such as the policy engine 115. The control points that do not satisfy the policy rules and constraints 282 are excluded from further analysis at 225. The remaining control points are further processed at 210.

Accordingly, at 210, the QoE controller can determine if the remaining control points satisfy a quality level target (e.g., target PQS). For example, the estimated quality level is received from a QoE estimator, such as the estimator 175. Control points that fail to meet the target quality level are excluded 225 from the analysis. The remaining control points are further processed at 215.

In some cases, the determination of whether or not the remaining control points satisfy the target PQS is made by predicting a PQS for each one of the remaining control points and comparing the predicted PQS with the target PQS to determine the control points to be excluded and control points to be further analyzed.

The PQS for the control points may be predicted as follows. First, a maximum PQS or a maximum spatial PQS that is achievable or reproducible at the client device may be determined based on the device type and the candidate resolution. Here, it is assumed that there are no other impairments and other factors that may affect video quality, such as reduced frame rate, quantization level, etc., are ideal. For example, a resolution of 640×360 on a tablet may yield a maximum PQS score of 4.3.

Second, the maximum spatial PQS score may be adjusted for the candidate frame rate of the control point to yield a frame rate adjusted PQS score. For example, a resolution of 640×360 on a tablet with a frame rate of 12 fps may yield a frame rate adjusted PQS score of 3.2.

Third, a quantization level may be selected that most closely achieves the target PQS given a particular resolution and frame rate. For example, if the target PQS is 2.7 and the control point has a resolution of 640×360 and frame rate of 12 fps, selecting an average quantization parameter of 30 (e.g., in the H.264 codec) achieves a PQS of 2.72. If the quantization parameter is increased to 31 (in the H.264 codec), the PQS estimate is 2.66.

Evaluator 170 can repeat the PQS prediction steps for one or more (and typically all) of the remaining control points. In some cases, one or more of the remaining control points may be incapable of achieving the target PQS. For example, of the 36 control points in the example of FIG. 2B, there may be resolution and frame rate combinations that may never achieve the target PQS irrespective of the quantization level. In particular, control points with frame rates of 8 or lower, and all resolutions of 288×160 or below, would yield a PQS that is below the target PQS of 2.7 regardless of the quantization parameter.

Evaluator 170 determines which of the control points would never achieve the target PQS, such as, for example, the target PQS of 2.7, and excludes 225 such control points,

At 215, the QoE controller determines if the remaining control points from 210 satisfy a delivery quality target or other such stalling metric. Accordingly, at 215, the QoE controller can determine if the remaining control points satisfy a delivery quality target (e.g., target DQS). The delivery quality target is received from a stall rate predictor, such as predictor 180. The control points that do not satisfy the delivery quality network are excluded 225 from the analysis. The remaining control points are considered at 220.

To determine whether the control points satisfy the delivery target value, a bit rate that would be produced by the remaining control points is predicted. In one example, the following model, based on the resolution, frame rate, quantization level and characteristics of the input bitstream (e.g. the input bit rate) may be used to predict the output bit rate:

bitsPerSecond=InputFactor*((A*log(MBPF)+B)*(e^{-C*FPS}+D))/((E−MBPF*F)^{QP})

InputFactor is an estimate of the complexity of the input content. This estimate may be based on the input bit rate. For example, an InputFactor with a value of 1.0 may mean average complexity. MBPF is an estimate of output macroblocks per frame. FPS is an estimate of output frames per second. Values A through F may be constants based on the characteristics of the encoder being used, which can be determined based on past encoding runs with the encoder. One example of a set of constant values for an encoder is: A=−296, B=2437, C=−0.0057, D=0.506, E=1.108, F=2.59220134e-05.

In some cases, control points that have an estimated bit rate that is at or near the bandwidth estimated to be available to the client on the network may be excluded 225 from the set of possible control points. This is because the predicted DOS may be too low to meet the overall QoE target.

At 220, the remaining control points are scored and ranked to select the best control point. The criteria for determining whether a control point is the best may be a penalty based model as discussed herein.

In some embodiments, one or more of 205, 210 and 215 may be omitted to provide a simplified evaluation. For example, in some embodiments, a target QoE may be based on PQS alone, and evaluator 170 may only perform target PQS evaluation, omitting policy evaluation and target DQS evaluation.

Table I illustrates example control points and associated parameter values to illustrate the scoring and ranking that may be performed by the evaluator 170.

TABLE I
Control Points and Associated Parameter Values

| | | | | | Estimated | Output | |
|---|---|---|---|---|---|---|---|
| Control | | | Frame | | Bit Rate | Macroblocks | Estimated |
| Point # | Width | Height | Rate | QP | (kbps) | per Second | PQS |
| 1 | 640 | 360 | 12.0 | 30 | 280 | 11040 | 2.72 |
| 2 | 428 | 240 | 24.0 | 31 | 290 | 10080 | 2.71 |
| 3 | 572 | 320 | 12.0 | 26 | 330 | 8640 | 2.70 |

Control points 1 to 3 in Table I are control points that, for example, meet the policy rules and constraints 282, and target QoE constraints. Evaluator 170 can compute scores (e.g., penalty values) for these remaining control points.

Output macroblocks per second may be computed directly from the output resolution and frame rate based on an average or estimated number of macroblocks for a given quantization level. The penalty values are computed based on the following optimization function discussed herein:

Penalty—Wb*Estimated kilobits per second+Wc*Output macroblocks per second+Wf*Frame Rate Penalty+Wr*Resolution Penalty+Wq*Quantization Penalty

In cases where optimization based solely on bit rate is desired, all the weights other than W_{b} in the optimization function may be set to 0. In that case, the control point with the lowest bit rate would be selected. In the example illustrated in table I, control point 1 would be selected for pure bit rate optimization.

In cases where optimization based on complexity is desired, all the weights other that W_{c} may be set to 0. Since complexity may be determined by the number of output macroblocks per second, the option with the lowest number of macroblocks per second would be selected. In the example illustrated in table I, control point 3 would be selected for pure complexity optimization.

In cases where a combined bit rate and complexity optimization is desired, both the bit rate and complexity can be taken into account. In this case, all the weights other than W_{b} and W_{c} may be set to 0. Table II illustrates example control points where W_{b} is set to 1 and W_{c} is set to 0.02 to determine a control point with the best balance of bit rate and complexity.

TABLE II
Control Points with W_{b} = 1 and W_{c} = 0.02

| | Estimated | Output | | | |
|---|---|---|---|---|---|
| Control | Bit Rate | Macroblocks | Bit rate | Complexity | Total |
| Point # | (kbps) | per Second | component | Component | Penalty |
| 1 | 280 | 11040 | 280 | 221 | 501 |
| 2 | 290 | 10080 | 290 | 202 | 492 |
| 3 | 330 | 8640 | 330 | 173 | 503 |

In this case, control point 2 is determined to have the best balance of bit rate and complexity, as it has the lowest total penalty.

In cases where a combined bit rate and frame rate optimization is desired, both the bit rate and the frame rate preferences can be taken into account. In this case, all the weights other than Wb and Wc may be set to 0. Table III illustrates example control points where the operator has specified a strong preference to avoid frame rates below 15 fps. In this case, both the W_{b} and the W_{f} may be set to 1 to determine the control point with the best balance of bit rate and frame rate.

TABLE III
Control Points with W_{b} = 1 and W_{f} = 1

| | Estimated | | | Frame Rate | |
|---|---|---|---|---|---|
| Control | Bit Rate | | Bit rate | Penalty | Total |
| Point # | (kbps) | Frame Rate | component | Component | Penalty |
| 1 | 280 | 12.0 | 260 | 300 | 580 |
| 2 | 290 | 24.0 | 290 | 0 | 290 |
| 3 | 330 | 12.0 | 330 | 300 | 630 |

Both the control points 1 and 2 may have a frame rate penalty of 300 applied due to the “strong” preference and the fact that their frame rates are below 15 fps. In this case, control point 2 may be the selected option.

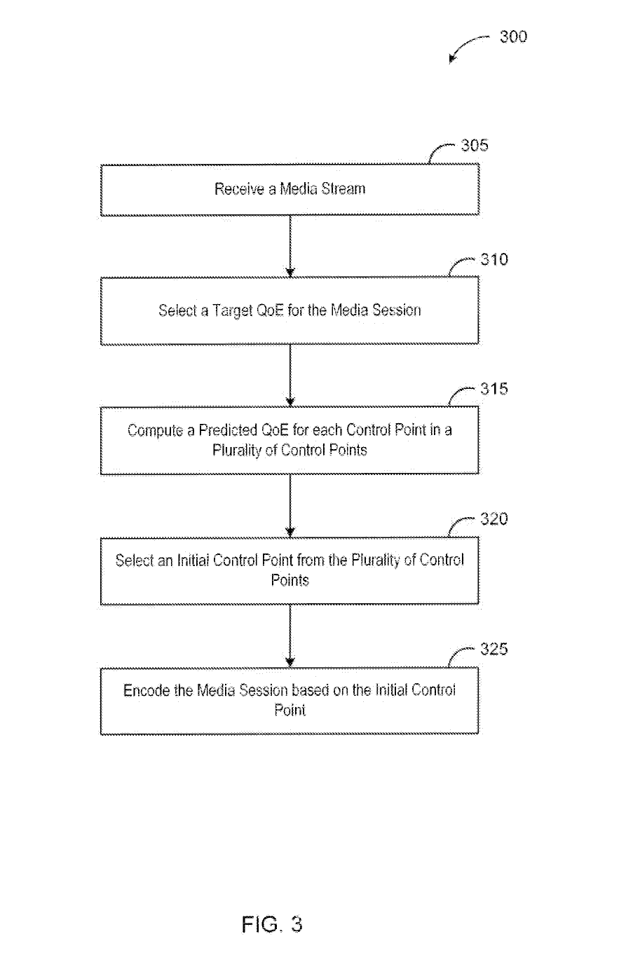

Reference is next made to FIG. 3, illustrating a process flow diagram 300 that may be executed by an exemplary QoE controller 110.

Process flow 300 begins at 305 by receiving a media stream, for example at the commencement of a media session.

At 310, the control system may select a target quality level—or target QoE—for the media session. The target QoE may be a composite value computed based on PQS, DQS or combinations thereof. In some cases, the target QoE may be a tuple comprising individual target scores, in general, target QoE may generally be weighted in favor of PQS, since this is easier to control. In some cases, the target QoE may be provided to the QoE controller by the policy engine, in some other cases, the target QoE may be calculated based on factors such as the viewing device, the content characteristics, subscriber preference, etc. In some further cases, the QoE controller may calculate the target QoE based on policy received from the policy engine. For example, the QoE controller may receive the policy that a larger viewing device screen requires a higher resolution for equivalent QoE than a smaller screen. In this case, the QoE controller may determine the target QoE based on this policy and the device size. It will be appreciated that in some cases the term QoE is not limited to values based on PQS or DQS. In some cases, QoE may be determined based on various one or more other objective or subjective metrics for determining a quality level.

Similarly, a policy may state that high action content, such as, for example, sports, requires a higher frame rate to achieve adequate QoE. The QoE controller may then determine the target QoE based on this policy and the content type.

Likewise, the policy may provide that the subscriber receiving the media session has a preference for better quantization at the cost of lower frame rate and/or resolution, or vice-versa. The QoE controller may then determine the target QoE based on this policy.

At 315, for a plurality of control points, a predicted quality level—or predicted QoE—associated with each control point may be computed as described herein. Each control point has a plurality of transcoding parameters, such as, for example, resolution, frame rate, quantization level, etc. associated with it.

QoE controller may generate a plurality of control points based on the input media session. The incoming media session may be processed by a decoder, such as decoder 150. The media session may be processed at an application and/or a container level to generate input stream statistics, such as the input stream statistics 188. The input stream statistics may be used by the QoE controller to generate a plurality of candidate control points. The plurality of candidate control points may, in addition or alternatively, be generated based on the policy rules and constraints, such as policy rules and constraints 182, 282.

At 320, an initial control point may be selected from the plurality of control points. The initial control point may be selected so that the predicted QoE associated with the initial control point substantially corresponds to the target QoE.

The initial control point may be selected based on the evaluation carried out by evaluator 170. The optimization function model to calculate penalties may be used by the evaluator 170 to select the initial control point as described herein. Selection of optimal control point may be based on one or more of the criteria such as minimizing bit rate, minimizing transcoding resource requirements and satisfying additional policy constrains, for example, device type, subscriber tier, service plan, time of the day etc.

In various cases, the QoE controller may compute the target QoE and/or the predicted QoE for a media stream in a media session for a range or duration of time, referred to as a “prediction horizon”. The duration of time for which the QoE is predicted or computed may be based on content complexity (motion, texture), quantization level, frame rate, resolution, and target device.

The QoE controller may anticipate the range of bit rates/quality-levels that are likely to be encountered in a session lifetime. Based on this anticipation, the QoE controller may select initial parameters, such as the initial control point, to provide most flexibility over life of the session. In some cases, some or all of the initial parameters selected by the QoE controller may be set to be unchangeable over life of the session.

At 325, the media session is encoded based on the initial control point. The media session may be encoded by an encoder, such as encoder 155.

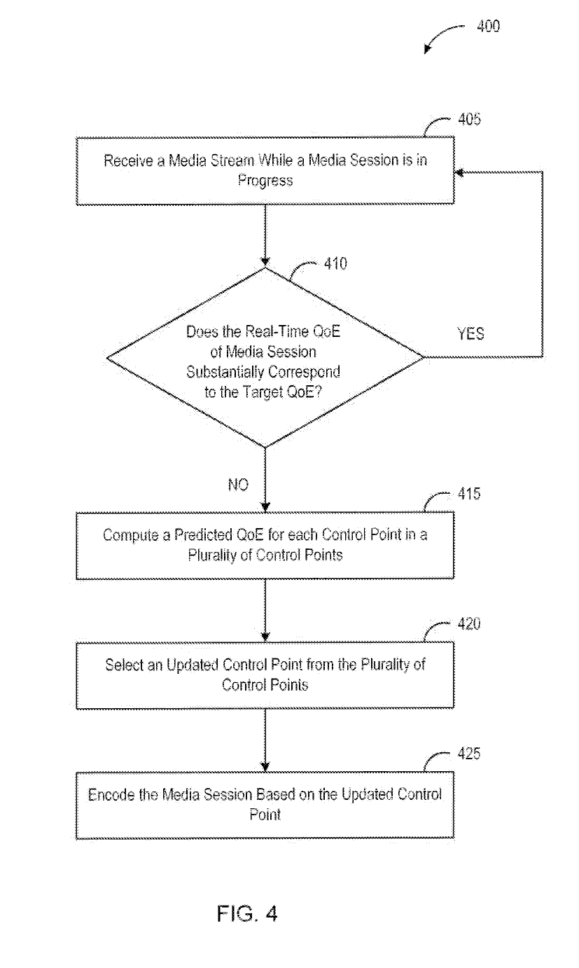

Reference is next made to FIG. 4, illustrating a process flow diagram that may be executed by an exemplary QoE controller 110.

Process flow 400 begins at 405 by receiving a media stream, for example while a media session is in progress. In some cases, process flow 400 may continue from 325 of process flow 300 in FIG. 3.

At 410, the QoE controller determines whether the real-time QoE of the media session substantially corresponds to the target QoE. The target QoE may be provided to the QoE controller by a policy engine, such as the policy engine 115. The target QoE may be set by the network operator. In addition, or alternatively, the target QoE may be calculated by the QoE controller as described herein.

If the real-time QoE substantially corresponds to the target QoE, no manipulation of the media stream need be carried out, and the QoE controller can continue to receive the media streams during the media session. However, if the real-time QoE does not substantially correspond to the target QoE, the process flow proceeds to 415.

At 415, for a plurality of control points, a predicted QoE associated with each control point may be re-computed using a process similar to 315 of process flow 300. The predicted QoE may be based on the real-time QoE of the media stream. In various cases, the interval for re-evaluation or re-computation is much shorter than the prediction horizon used by the QoE controller.

At 420, an updated control point may be selected from the plurality of control points using a process similar to 320 of process flow 300. The updated control point is selected so that the predicted QoE associated with the updated control point substantially corresponds to the target QoE. The updated control point may be selected based on the evaluation carried out by evaluator 170. The optimization function model to calculate penalties may be used by the evaluator 170 to select the updated control point.

At 425, the media session may be encoded based on the updated control point. The media session may be encoded by an encoder, such as encoder 155. Accordingly, if the media session was initially being encoded using an initial control point, the encoder may switch to using an updated control point following its selection at 520.

As described herein, the target and the predicted QoE computed in process flows 300 and 400 may be based on the visual presentation quality of the media session, such as that determined by a PQS score. In some cases, the target and the predicted QoE may be based on the delivery network quality, such as that determined by the DQS score. In some further cases, the target and the predicted QoE correspond to a combined presentation and network delivery score, as determined by COS.

In cases where the target and the predicted QoE are based on the PQS, the elements related to network delivery may be optional. For example, in such cases, the network resource model 120 and the client buffer model 125 of system 100 may be optional. Similarly, predictor 180 of the QoE controller 110 may be an optional.

In cases where the target and the predicted QoE are based on the combined quality score, i.e. CQS, the target PQS and target DQS may be combined into the single target score or CQS. The CQS may be computed according to the following formula, for example:

CQS=C0+C1*(PQS+DQS)+C2*(PQS*DQS)+C3*(PQŜ2)*(DQŜ2)

In one example, the values C0, C1, C2, C3 and C4 may be constants having the following values: C0=1.1664, C=−0.22935, C3=0.29243 and C4=−0.0016098. In some other cases, the constants may be given different values by, for example, a network operator. In general, CQS scores give more influence to the lower of the two scores, namely PQS and DQS.

Various embodiments are described herein in relation to video streaming, which will be understood to include audio and video components. However, the described embodiments may also be used in relation to audio-only streaming, or video-only streaming, or other multimedia streams including an audio or video component.

In some cases, audio and video streams may both be combined to compute an overall PQS, for example, according to the following formula:

(Video_weight*(Video_{—}PQSp)+Audio_weight*(Audio_{—}PQSp))^{(1/p)}

Video_weight and Audio_weight may be selected so that their sum is 1. Based on the determination regarding the importance of the audio or the video, the weights may be adjusted accordingly. For example, if it is decided that video is more important, then the Video_weight may be ⅔ and the Audio_weight may be ⅓.

The value of p may determine how much influence the lower of the two input values has on the final score. A value of p between 1 and −1 may give more influence to the lower of the two inputs. For example, if a video stream is very bad, then the whole score may be very bad, no matter how good the audio. In various cases, p=−0.25 may be used for both the audio and the video streams.

The described embodiments generally enable service providers to provide their subscribers with assurance that content they access will conform to one or more agreed upon quality levels, permitting creation of pricing models based on the quality of their subscribers' experiences. The described embodiments also enable service providers to provide content providers and aggregators with assurances that their content will be delivered at one or more agreed upon quality levels, permitting creation of pricing models based on an assured level of content quality. In addition, the described embodiments enable service providers to deliver the same or similar video quality across one or more disparate media sessions in a given network location,

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. The scope of the claims should not be limited by the preferred embodiments and examples, but should be given the broadest interpretation consistent with the description as a whole.

We claim:

1. A method of controlling transcoding of a media session by a transcoder on a network, the method comprising:
selecting a target quality of experience (QoE) for the media session;
for each of a plurality of control points, computing a predicted QoE associated with the control point, wherein each control point has a plurality of transcoding parameters associated therewith;
selecting an initial control point of the plurality of control points, wherein the predicted QoE for the initial control point substantially corresponds with the target QoE; and
signaling the transcoder to use the initial control point for the media session.

2. The method of claim 1, wherein the initial control point is selected based on an optimization function.

3. The method of claim 1, further comprising,
determining that a real-time QoE for the media session does not substantially correspond with the target QoE;
for each of the plurality of control points, re-computing the predicted QoE, wherein the predicted QoE is based on a real-time QoE for the media session;
selecting an updated control point from the plurality of control points, wherein the predicted QoE for the updated control point substantially corresponds with the target QoE; and
signaling the transcoder to use the updated control point for the media session.

4. The method of claim 3, further comprising determining a client buffer condition, wherein the updated control point is selected based on the client buffer condition.

5. The method of claim 1, wherein the updated control point is selected based on an optimization function.

6. The method of claim 5, wherein a policy rule is an input to the optimization function.

7. The method of claim 5, wherein at least one device capability of a device receiving the media session is an input to the optimization function.

8. The method of claim 5, wherein a bit rate of the media session is an input to the optimization function.

9. The method of claim 5, wherein transcoding resource requirements are an input to the optimization function.

10. The method of claim 1, wherein the plurality of transcoding parameters comprise at least one parameter selected from the group consisting of: quantization level, resolution, and frame rate.

11. The method of claim 1, wherein the predicted QoE is computed for a predetermined forward window, and wherein the selected control point is selected to substantially correspond with the target QoE over the length of the predetermined forward window.

12. The method of claim 1, wherein the target QoE comprises a QoE range.

13. The method of claim 1, wherein QoE is computed based on at least one of a presentation quality score and a delivery quality score.

14. An apparatus for controlling transcoding of a media session by a transcoder on a network, the apparatus comprising:
a memory;
a network interface;
a processor, the processor configured to:
select a target quality of experience (QoE) for the media session;
for each of a plurality of control points, compute a predicted QoE associated with the control point, wherein each control point has a plurality of transcoding parameters associated therewith;
select an initial control point of the plurality of control points, wherein the predicted QoE for the initial control point substantially corresponds with the target QoE; and
signal the transcoder to use the initial control point for the media session.

15. The apparatus of claim 14, wherein the processor is further configured to:
determine that a real-time QoE for the media session does not substantially correspond with the target QoE;
for each of the plurality of control points, re-computing the predicted QoE, wherein the predicted QoE is based on a real-time QoE for the media session;
select an updated control point from the plurality of control points, wherein the predicted QoE for the updated control point substantially corresponds with the target QoE; and
signal the transcoder to use the updated control point for the media session.

16. The apparatus of claim 15, wherein the processor is further configured to determine a client buffer condition, wherein the updated control point is selected based on the client buffer condition.

17. The apparatus of claim 15, wherein the processor is further configured to select the updated control point based on an optimization function.

18. The apparatus of claim 15, wherein the processor is configured to compute the predicted QoE for a predetermined forward window, and wherein the processor is configured to select the updated control point to substantially correspond with the target QoE over the length of the predetermined forward window.

19. A non-transitory computer-readable medium storing computer-executable instructions, the instructions for causing a processor to perform a method of controlling transcoding of a media session by a transcoder on a network, the method comprising:
selecting a target quality of experience (QoE) for the media session;
for each of a plurality of control points, computing a predicted QoE associated with the control point, wherein each control point has a plurality of transcoding parameters associated therewith;
selecting an initial control point of the plurality of control points, wherein the predicted QoE for the initial control point substantially corresponds with the target QoE; and
signaling the transcoder to use the initial control point for the media session.

20. The computer-readable medium of claim 19, wherein the method further comprises:
determining that a real-time QoE for the media session does not substantially correspond with the target QoE;
for each of the plurality of control points, re-computing the predicted QoE, wherein the predicted QoE is based on a real-time QoE for the media session;
selecting an updated control point from the plurality of control points, wherein the predicted QoE for the updated control point substantially corresponds with the target QoE; and
signaling the transcoder to use the updated control point for the media session.
